(19) United States
(12) Patent Application Publication
(10) Pub. No.: US 2011/0175706 A1
(43) Pub. Date: Jul. 21, 2011

(54) RADIO FREQUENCY IDENTIFICATION TAG

(75) Inventors: Yin-Hung TSENG, Chiayi City (TW); Sheng-Chun Hsu, Taitung Hsien (TW)

(73) Assignee: USERSTAR INFORMATION SYSTEM CO., LTD.

(21) Appl. No.: 12/689,982

(22) Filed: Jan. 19, 2010

(51) Int. Cl. H04Q 5/22; G06K 19/00

(52) U.S. Cl. 340/10.1; 235/492

(57) ABSTRACT

An RFID tag includes a substrate, a chip, a conductive unit, and an antenna. The substrate is attached to an article. The chip is disposed on the substrate to partition the substrate into a first region on one side of the chip and a second region on the other side of the chip. The conductive unit is coupled electrically to the chip, and is disposed on the substrate to form a loop in cooperation with the chip. The antenna is disposed on the substrate and coupled electrically to the chip. The loop and an area of the substrate encompassed thereby are disposed in the first region, and the antenna is disposed in the second region. Removal of the substrate from the article results in a break in the conductive unit, and the chip is operable to detect the break in the conductive unit.

### BACKGROUND OF THE INVENTION

1. Field of the Invention

The present invention relates to a radio frequency identification (RFID) tag, in which removal of the RFID tag from an article may be detected by a chip of the RFID tag.

2. Description of the Related Art

Referring to FIG. 1, U.S. Pat. No. 7,516,901 discloses an RFID tag that includes a film sheet 50, an IC (integrated circuit) chip 52 disposed on the film sheet 50, an antenna 54 disposed on the film sheet 50 and coupled electrically to the IC chip 52, and a detecting block 56 disposed on the film sheet 50 and coupled electrically to the chip 52. The detecting block 56 is formed into a loop.

After the above conventional RFID tag is attached to an article (not shown), removal of the RFID tag from the article by peeling the film sheet 50 off of the same results in a break in the loop of the detecting block 56. The IC chip 52 of the RFID tag is capable of detecting such a break in the loop of the detecting block 56. Subsequently, when a reader (not shown) is used to read the RFID tag, information of the break in the detecting block 56 may be transferred from the IC chip 52 to the reader.

The conventional RFID tag may be used to prevent a certain type of shoplifting, in which a shoplifter removes the conventional RFID tag from an inexpensive article and re-attaches the same onto an expensive article in an attempt to purchase the expensive article at the lower price of the inexpensive article. Store employees may then be alerted to the possibility of such illicit use of the RFID tag when it is read by a reader.

However, a drawback of the conventional RFID tag is that positioning of the detecting block 56 surrounding and in such close proximity to the antenna 54 reduces the gain of the antenna 54. Moreover, such a configuration of the conventional RFID tag makes it difficult to reduce the overall size of the RFID tag.

### SUMMARY OF THE INVENTION

Therefore, the object of the present invention is to provide a radio frequency identification (RFID) tag capable of alleviating the above drawbacks of the prior art.

According to this invention, an RFID tag comprises: a substrate adapted to be attached to an article; a chip disposed on the substrate to thereby partition the substrate into a first region on one side of the chip and a second region on the other side of the chip; a conductive unit coupled electrically to the chip, and disposed on the substrate in such a manner as to form at least one loop in cooperation with the chip; and an antenna disposed on the substrate and coupled electrically to the chip.

The at least one loop formed by the conductive unit and the chip, and an area of the substrate encompassed by the at least one loop are disposed in the first region of the substrate, and the antenna is disposed in the second region of the substrate.

Removal of the substrate from the article results in a break in the conductive unit, and the chip is operable to detect the break in the conductive unit.

### BRIEF DESCRIPTION OF THE DRAWINGS

Other features and advantages of the present invent ion will become apparent in the following detailed description of the preferred embodiments with reference to the accompanying drawings, of which:

FIG. 1 is a schematic view of a conventional radio frequency identification (RFID) tag;

FIG. 2 is a schematic view of an RFID tag according to a first preferred embodiment of the present invention;

FIG. 3 is a waveform diagram of a digital signal output by an output terminal of a chip of the RFID tag of FIG. 2 and the same digital signal received by an input terminal of the chip;

FIG. 4 is a view similar to FIG. 2, but illustrating a break formed in a conductive unit of the RFID tag;

FIG. 5 is a waveform diagram similar to FIG. 3, but illustrating how the digital signal is not received by the input terminal of the chip due to the break in the conductive unit;

FIG. 6 is a schematic view illustrating an alternative configuration of the conductive unit of the RFID tag according to the first preferred embodiment;

FIG. 7 is a schematic view illustrating another alternative configuration of the conductive unit of the RFID tag according to the first preferred embodiment;

FIG. 8 is a schematic view illustrating an alternative configuration of an antenna of the RFID tag according to the first preferred embodiment;

FIG. 9 is a schematic view of an RFID tag according to a second preferred embodiment of the present invention;

FIGS. 10 and 11 are schematic diagram, illustrating the RFID tag according to the second preferred embodiment respectively after it is placed around an article and after heat is applied to the RFID tag;

FIG. 12 is a schematic view of an RFID tag according to a third preferred embodiment of the present invention; and

FIG. 13 shows schematic views of an RFID tag of the present invention and a conventional RFID tag, and is used to describe how the RFID tag of the present invention has an area smaller than that of the conventional RFID tag.

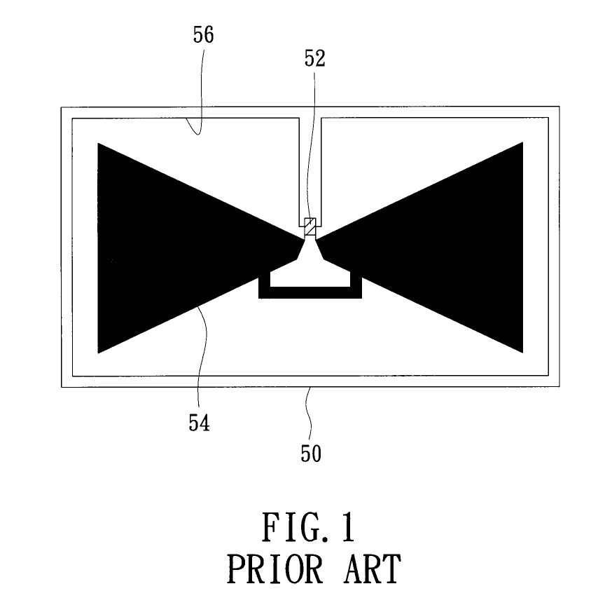

### DETAILED DESCRIPTION OF THE PREFERRED EMBODIMENTS

Before the present invention is described in greater detail, it should be noted that like elements are denoted by the same reference numerals throughout the disclosure.

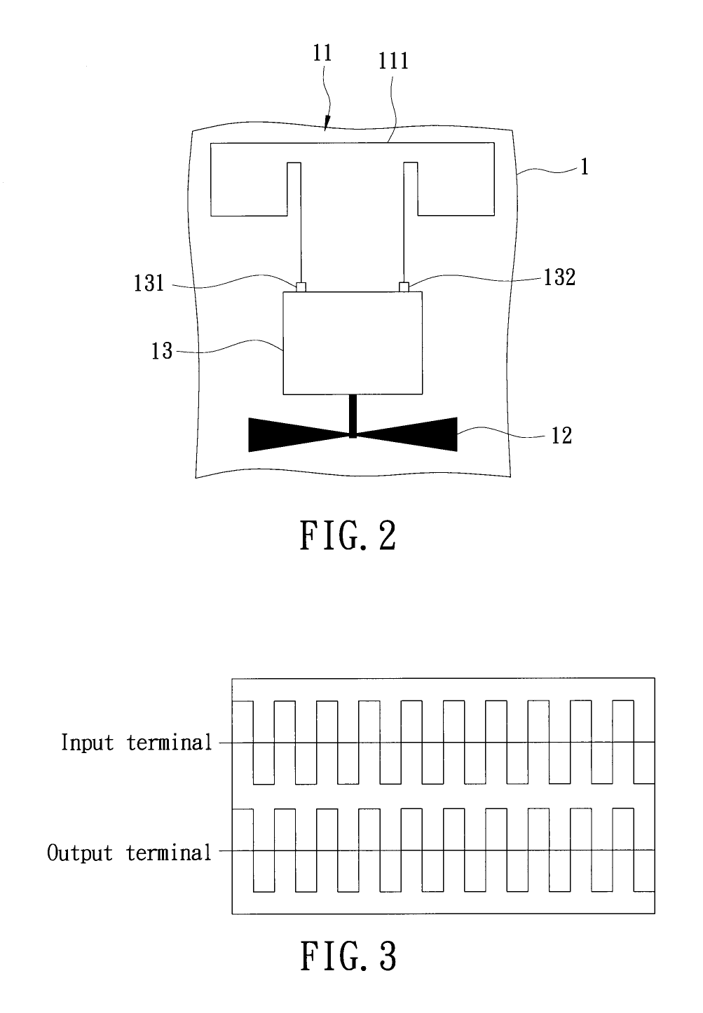

Referring to FIG. 2, a radio frequency identification (RFID) tag according to a first preferred embodiment of the present invention comprises a substrate 1, a chip 13, a conductive unit 11, and an antenna 12.

The substrate 1 is adapted to be attached to an article (not shown).

The chip 13 is disposed on the substrate 1, and partitions the substrate 1 into a first region on one side of the chip 13 and a second region on the other side of the chip 13.

The conductive unit 11 is coupled electrically to the chip 13, and is disposed on the substrate 1 in such a manner as to form at least one loop in cooperation with the chip 13. In the first preferred embodiment, the conductive unit 11 includes a single conductive member 111 that forms one loop in cooperation with the chip 13.

The antenna 12 is disposed on the substrate 1 and is coupled electrically to the chip 13.

The loop formed by the chip 13 and the conductive member 111 of the conductive unit 11, and an area of the substrate 1 encompassed by the loop are disposed in the first region of the substrate 1. The antenna 12 is disposed in the second region of the substrate 1.

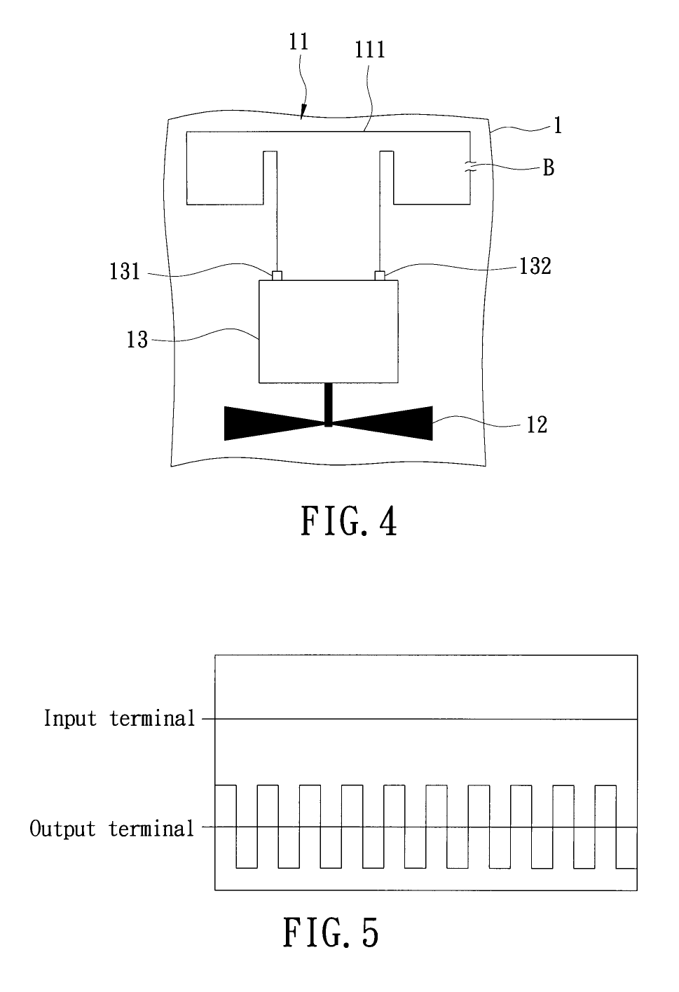

Referring to FIG. 4, removal of the substrate 1 from the article results in a break (B) in the conductive member 111 of the conductive unit 11. The chip 13 is operable to detect the break (B) in the conductive member 111 of the conductive unit 11.

In the first preferred embodiment, the chip 13 has an input terminal 131 and an output terminal 132, and the conductive member 111 of the conductive unit 11 interconnects the input and output terminals 131, 132 of the chip 13.

Referring to FIGS. 2 and 3, under normal conditions, the chip 13 generates an output signal, and transmits the output signal generated thereby through the output terminal 131 for receipt by the input terminal 131 as an input signal.

Referring to FIGS. 4 and 5, when there is a break (B) in the conductive member 111 of the conductive unit 11, the output signal transmitted through the output terminal 132 is not received by the input terminal 131. As a result, the chip 13 determines that the conductive member 111 of the conductive unit 11 has the break (B) therein.

In some embodiments, the output signal generated by the chip 13 is a voltage. In other embodiments, the output signal generated by the chip 13 is a digital signal, as shown in FIGS. 3 and 5.

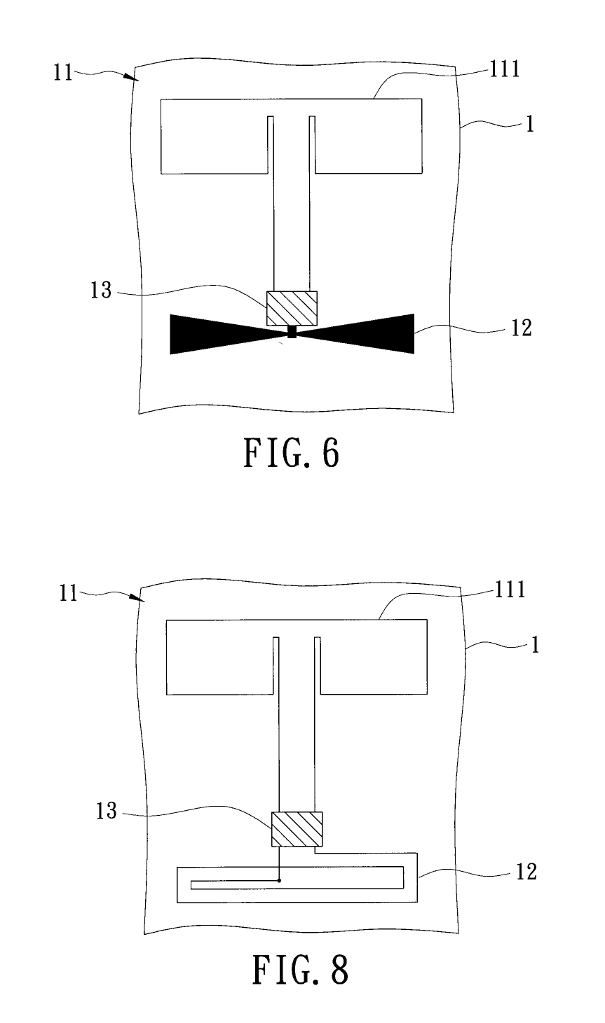

Referring to FIG. 6, in some embodiments, the conductive member 111 of the conductive unit 11 is slightly altered in shape. For example, the portions of the conductive member 111 that are connected to the chip 13 extend as straight lines for some distance before bending to form the loop.

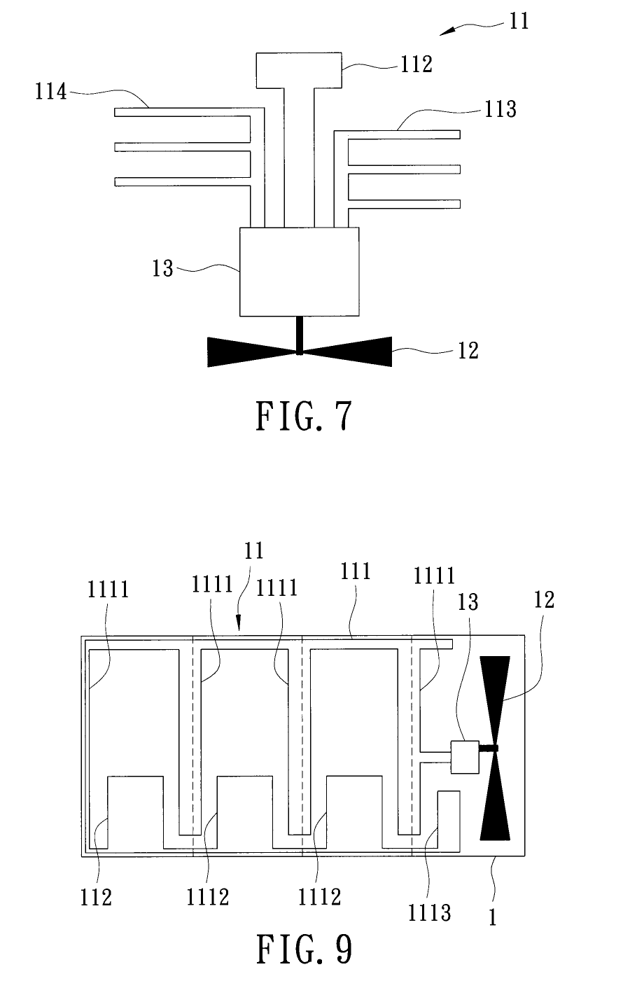

Referring to FIG. 7, in some embodiments, the conductive unit 11 includes a plurality of conductive members 112, 113, 114, each forming a loop in cooperation with the chip 13. Each loop, and an area of the substrate 1 encompassed by said each loop are disposed in the first region of the substrate 1.

Referring to FIG. 8, in some embodiments, the antenna is formed using a single conductive wire-like structure that is connected to the chip 13 on both ends thereof.

The RFID tag according to a second preferred embodiment of the present invention will now be described with reference to FIG. 9.

In the second preferred embodiment, the substrate 1 is in the form of a heat-shrink material. Moreover, the conductive member 111 of the conductive unit 11 forms one loop in cooperation with chip 13 as in the first embodiment. However, in this embodiment, the conductive member 111 is formed in the shape as shown in FIG. 9. In particular, in the second preferred embodiment, the loop formed by the conductive member 111 of the conductive unit 11 includes four first sections 1111 that are spaced apart in the lengthwise direction of the substrate 1 and that extend in a widthwise direction of the substrate 1, three second sections 1112 that extend in the widthwise direction of the substrate 11 and partway into gaps formed between the first sections 1111, and a third section 1113 that extends in the widthwise direction of the substrate 1 in proximity to the chip 13.

The conductive member 111 of the conductive unit 11 is not limited to the configuration described above and shown in FIG. 9, which is merely an exemplary structure that allows for multiple points at which the conductive unit 11 may experience a break upon removal of the substrate 1 from an article. The conductive member 111 of the conductive unit 11 may be formed into other shapes to achieve the same purpose.

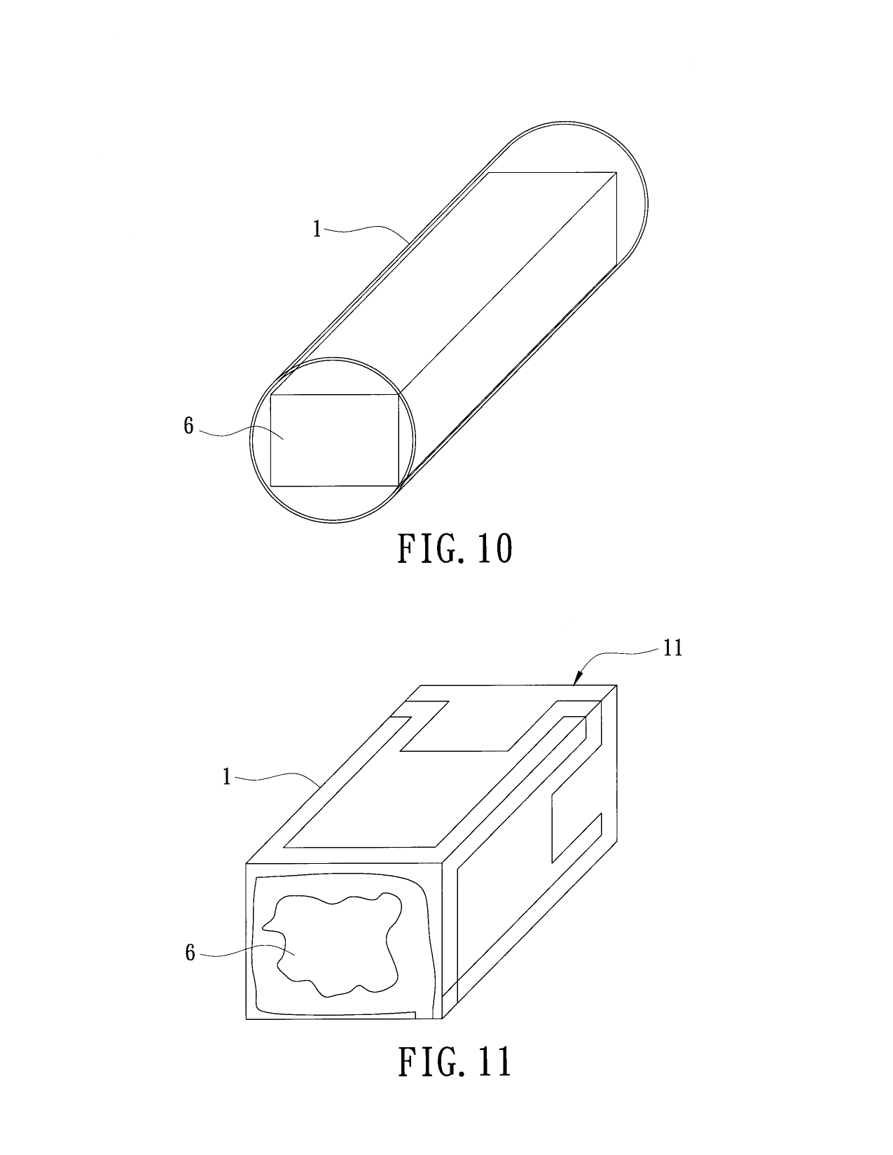

Referring to FIGS. 10 and 11, the RFID tag of the second preferred embodiment may be placed around an article 6, after which heat may be applied to the RFID tag such that the substrate 1, together with the chip 13, the conductive unit 11, and the antenna 12 formed thereon, conform to the shape of the article 6.

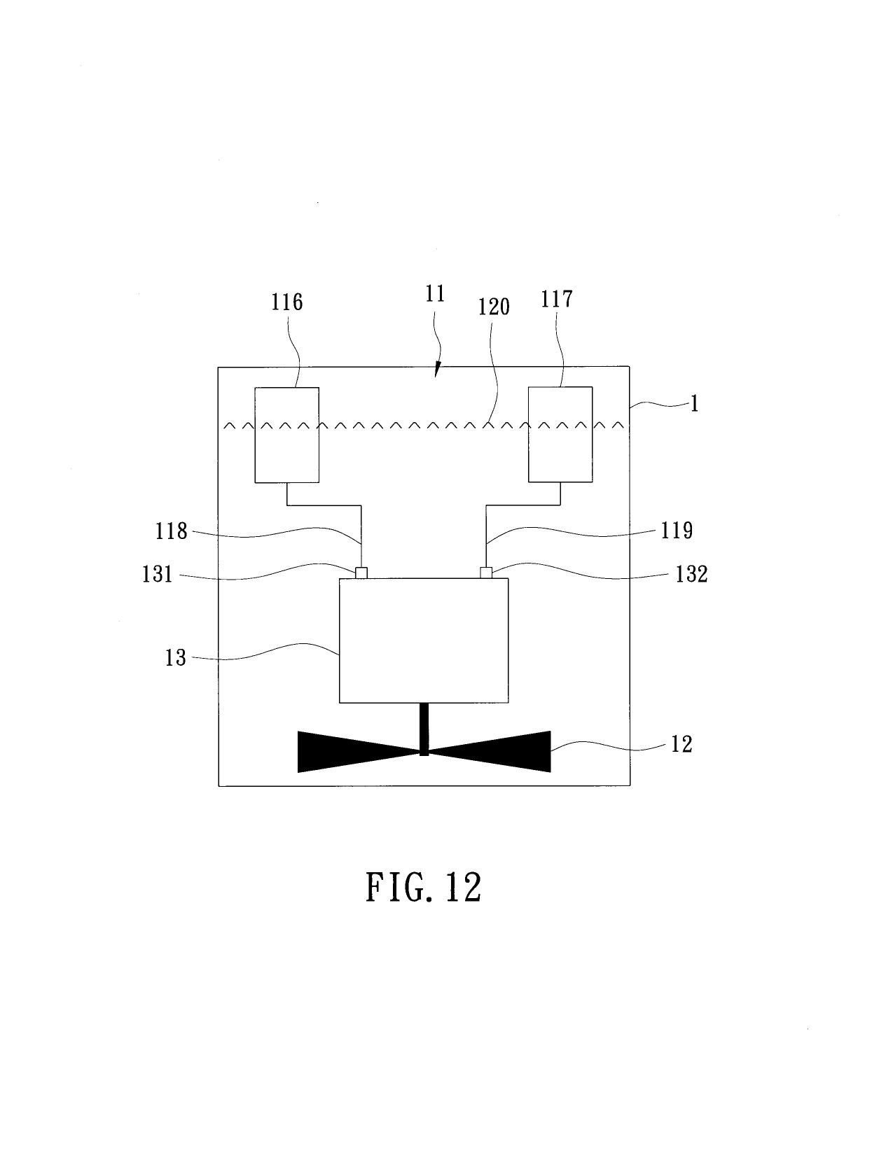

The RFID tag according to a third preferred embodiment of the present invention will now be described with reference to FIG. 12.

In the third preferred embodiment, the conductive unit 11 includes first and second conductive portions 116, 117, first and second connecting legs 118, 119 electrically interconnecting the first and second conductive portions 116, 117 respectively to the output and input terminals 131, 132 of the chip 13, and an attaching portion 120 electrically coupling the first and second conductive portions 116, 117 to each other.

The attaching portion 120 is in the form of an electrically conductive thread for sewing the first and second conductive portions 116, 117 of the conductive unit 11 and the first region of the substrate 1 on an article (not shown). When the substrate 1 is removed from the article, a break in the attaching portion 120 occurs, such that the first and second conductive portions 116, 117 are no longer electrically coupled to each other. Since the output signal is not received by the input terminal 132 when this occurs, the chip 13 determines that there is a break in the conductive unit 11.

In any of the embodiments of the present invention described above, when the chip 13 detects a break in the conductive unit 11, this may be indicative of an attempt to use the RFID tag for illicit purposes. For example, the RFID tag may be removed from an inexpensive article and attached to (or placed on or in) an expensive article with the aim of purchasing the expensive article at the lower price of the inexpensive article. Thereafter, when a reader (not shown) is used to read the RFID tag, the chip 13 may transmit a signal to the reader which indicates that a break in the conductive unit 11 has been detected, thereby alerting store personnel to check whether the RFID tag associated with the article is the correct one or has been replaced with an RFID tag for another article.

In the RFID tag of the present invention described above, at least one loop is formed by the conductive unit 11 and the chip 13, and this at least one loop and the area of the substrate 1 encompassed thereby are disposed in the first region of the substrate 1, while the antenna 12 is disposed in the second region of the substrate 1. Because of the separation between the conductive unit 11 and the antenna 12, a high gain of the antenna 12 may be maintained. That is, the conductive unit 11 does not cause a drop in the gain of the antenna 12 since it is separated therefrom.

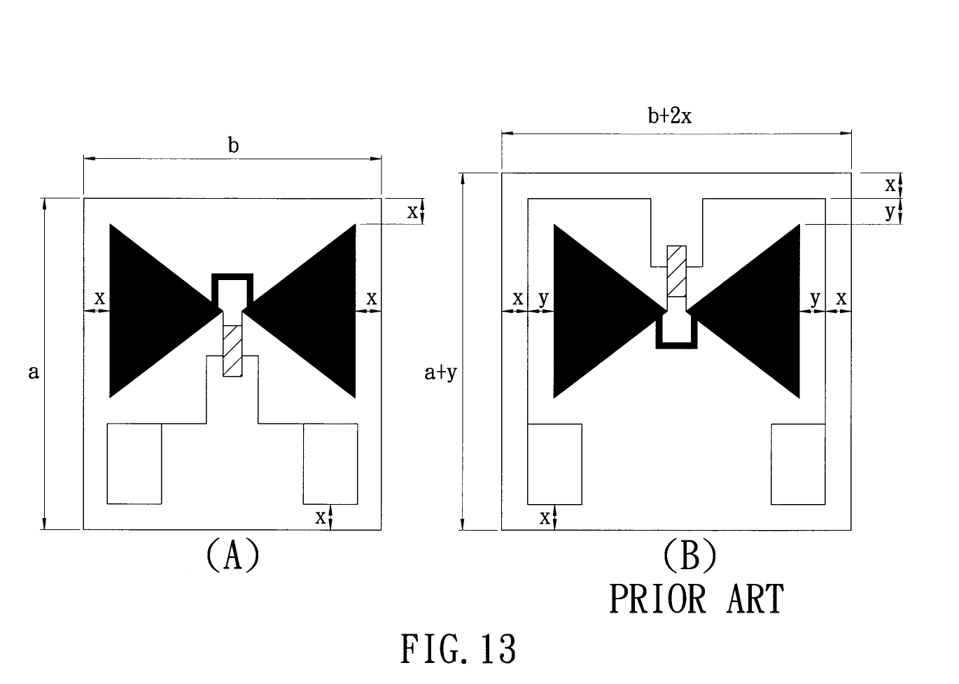

Referring to FIG. 13, which shows another exemplary configuration of the RFID tag of the present invention (on the left) next to a conventional RFID tag (on the right). In the present invention, since the at least one loop and the area of the substrate 1 encompassed thereby are disposed in the first region of the substrate 1, while the antenna 12 is disposed in the second region of the substrate 1, the total size of the RFID tag may be reduced, when compared to the conventional RFID tag. That is, while the RFID tag of the present invention has an area of (a*b), the conventional RFID tag has an area of (a+y) (b+2x). More precisely, the area (β) of the RFID tag of the present invention is ab, while the area (α) of the conventional RFID tag shown in FIG. 13 is (a+y) (b+2x)=ab+by+2xa+2xy. Therefore, the difference α−β is by+2ax+2xy.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A radio frequency identification (RFID) tag, comprising:
a substrate adapted to be attached to an article;
a chip disposed on said substrate to thereby partition said substrate into a first region on one side of said chip and a second region on the other side of said chip;
a conductive unit coupled electrically to said chip, and disposed on said substrate in such a manner as to form at least one loop in cooperation with said chip; and
an antenna disposed on said substrate and coupled electrically to said chip;
wherein said at least one loop formed by said conductive unit and said chip, and an area of said substrate encompassed by said at least one loop are disposed in said first region of said substrate, and said antenna is disposed in said second region of said substrate; and
wherein removal of said substrate from the article results in a break in said conductive unit, and said chip is operable to detect said break in said conductive unit.

2. The RFID tag of claim 1, wherein said chip has input and output terminals,
said conductive unit interconnecting said input and output terminals of said chip,
said chip generating an output signal, and transmitting the output signal generated thereby through said output terminal thereof,
said chip detecting that said conductive unit has a break therein when the output signal transmitted thereby is not received by said input terminal thereof.

3. The RFID tag of claim 2, wherein said conductive unit includes first and second conductive portions, first and second connecting legs electrically interconnecting said first and second conductive portions respectively to said output and input terminals of said chip, and an attaching portion electrically coupling said first and second conductive portions to each other;
wherein said attaching portion is in the form of an electrically conductive thread for sewing said first and second conductive portions of said conductive unit and said first region of said substrate on the article.

4. The RFID tag of claim 2, wherein the output signal generated by said chip is a voltage.

5. The RFID tag of claim 2, wherein the output signal generated by said chip is a digital signal.

6. The RFID tag of claim 1, wherein said substrate is in the form of a heat-shrink material.
